(19) United States
(12) Patent Application Publication
(10) Pub. No.: US 2002/0107736 A1
(43) Pub. Date: Aug. 8, 2002

(54) Electronic commerce advertising method and system

(76) Inventors: Yasuhiko Mizuno, Sakura (JP); Takeshi Matsuki, Musashino (JP); Shuji Terada, Kawasaki (JP); Hideo Noyama, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/954,375

(22) Filed: Sep. 12, 2001

(30) Foreign Application Priority Data
Feb. 8, 2001 (JP) 2001-031866

(51) Int. Cl. G06F 17/60

(52) U.S. Cl. 705/14

(57) ABSTRACT

Embodiments of the present invention are directed to a method and a system for clarifying amounts of purchases at an actual store that are associated with electronic advertisements presented in an electronic mall and for calculating electronic advertising fees in an appropriate manner based on these amounts. Upon displaying contents of an electronic advertisement for a store on a user terminal via a network, coupon information containing information which identifies the store is stored in the user terminal. An advertising fee is calculated for displaying the electronic advertisement based on a product purchase amount if the coupon information stored in the user terminal is transmitted to the store. Alternatively, the electronic advertising fee can be calculated based on points assigned when products are purchased.

### CROSS-REFERENCES TO RELATED APPLICATIONS

This application is related to and claims priority from Japanese Patent Application No. 2001-031866, filed Feb. 8, 2001, the disclosure of which is incorporated herein by reference.

### BACKGROUND OF THE INVENTION

The present invention relates to an electronic advertising system in which an operator of a store puts out an electronic advertisement in an electronic mall and pays advertising fees to an operator of the electronic mall. More specifically, the present invention relates to a method for calculating electronic advertising fees that permit the setting of rational advertising fee payments based on actual purchase amounts of users visiting a store.

With the increasing number of Internet users in recent years, electronic advertising systems in which product advertisements are presented through electronic malls are seeing greater use. In these electronic advertising systems, the operator of a store presenting an electronic advertisement in an electronic mall pays advertising fees based on the benefits provided by the electronic advertisement through either an “exposure count assurance model” that uses the frequency with which the advertisement is presented; or a “click assurance model” that uses the number of people viewing the advertisement [reference: page 7, Nihon Keizai Shinbun morning edition, Aug. 13, 2000]. However, these methods do not provide information about how many of the purchasers viewed the advertisement. An example of a method for overcoming this problem is described on page 7 of the Aug. 13, 2000, Nihon Keizai Shinbun morning edition. In this method, when a product is sold, the electronic mall shopping system traces the past actions of the purchaser on the Internet and determines whether the advertisement was viewed. If the advertisement was viewed, an advertising fee is paid, and if the advertisement was not viewed the advertising fee does not need to be paid. Thus, advertising fees need be paid only if there was actual benefit from the advertisement.

This conventional technology has the following problems. First, when a product is sold through a virtual store in an electronic mall, the user's past actions on the Internet can be traced to determine which electronic advertisements were viewed. However, if a user sees an electronic advertisement advertising a store and makes a purchase at the actual store, there is no way to determine if the electronic advertisement provided benefit. Thus, for the store operator presenting the electronic advertisement, the benefits from the electronic advertisement cannot be accurately evaluated. Second, the operator of the electronic mall presenting the electronic advertisement cannot accurately evaluate the benefits from the electronic advertisement, and cannot present the store operator with a rational basis for the advertising fee.

### BRIEF SUMMARY OF THE INVENTION

Embodiments of the present invention are directed to a method and a system for clarifying amounts of purchases at an actual store that are associated with electronic advertisements presented in an electronic mall and for calculating electronic advertising fees in an appropriate manner based on these amounts.

An aspect of the present invention is directed to a method of calculating advertising fees for an electronic advertisement in a network environment for conducting electronic commerce activities. The method comprises displaying contents of an electronic advertisement for a store on a user terminal via a network, and storing in the user terminal, via the network, coupon information containing information which identifies the store. An advertising fee is calculated for displaying the electronic advertisement based on a product purchase amount if the coupon information stored in the user terminal is transmitted to the store. In another embodiment, the electronic advertising fee can be calculated based on points assigned when products are purchased.

In accordance with another aspect of the present invention, a method of calculating advertising fees for an electronic advertisement comprises sending an electronic advertisement about a store to a user, generating coupon information containing information which identifies the store and sending the coupon information to the user, and receiving from the store reports on coupon usage and product purchase amounts associated with the coupon information sent to the user. Advertising fees are calculated for sending the electronic advertisement about the store based on the reported coupon usage and product purchase amounts.

In accordance with another aspect of the invention, a system of calculating advertising fees for an electronic advertisement includes an electronic mall server which comprises an advertisement sending module configured to send an electronic advertisement about a store to a user. A coupon generating module is configured to generate coupon information containing information which identifies the store and send the coupon information to the user. A coupon usage module is configured to receive from the store reports on coupon usage and product purchase amounts associated with the coupon information sent to the user. A fee calculating module is configured to calculate advertising fees for sending the electronic advertisement about the store based on the reported coupon usage and product purchase amounts.

In some embodiments, a user terminal at the user receives the electronic advertisement and the coupon information from the electronic mall server. The user terminal comprises an advertisement receiving module configured to receive the electronic advertisement from the electronic mall server, and a coupon receiving module configured to receive and store the coupon information from the electronic mall server. A store terminal at the store comprises a coupon storage module configured to store coupon information transferred from the user terminal, and a purchase reporting module configured to report to the electronic mall server amounts of product purchases associated with the coupon information sent to the user.

Specific embodiments of the invention are directed to programs that implement the functions described above or storage media storing such programs.

### BRIEF DESCRIPTION OF THE DRAWINGS

FIG. 1 is a block diagram showing the system architecture of an electronic mall system according to an embodiment of the invention.

FIG. 2 is a block diagram showing the architecture of a store terminal 3 according to an embodiment of the invention.

FIG. 3 shows a sample entry in a product database 24.

FIG. 4 shows a sample entry in a store database 25.

FIG. 5 shows sample coupon information sent to a shopping terminal.

FIG. 6 shows a sample entry in an issued coupon history database 26.

FIG. 7 shows a sample entry in a product transaction merchant database 27.

FIG. 8 shows a sample entry in a user database 28.

FIG. 9 shows a sample store code 36.

FIG. 10 shows a sample entry in a coupon usage history database 37.

FIG. 11 shows a sample entry in a sales history database 38.

FIG. 12 shows a sample entry in a product master list 39.

FIG. 13 shows a sample entry in a electronic mall volume database 40.

FIG. 14 is a flowchart showing an example of the operations performed to issue coupons according to an embodiment of the invention.

FIG. 15 is a flowchart showing an example of the operations performed to carry out transactions at a store terminal 3 according to an embodiment of the invention.

FIG. 16 is a flowchart showing an example of the operations performed by electronic mall server 2 to update point counts according to an embodiment of the invention.

FIG. 17 is a flowchart showing an example of the operations performed by electronic mall server 2 to calculate advertising fees according to an embodiment of the invention.

FIG. 18 is a flowchart showing an example of the operations performed by electronic mall server 2 to calculate advertising fees according to another embodiment of the invention.

### DETAILED DESCRIPTION OF THE INVENTION

Specific embodiments of the present invention are described below with reference to the drawings. In some embodiments, a store in an electronic mall is selected and a coupon for the store is obtained. A user wishing to purchase a product takes the coupon to the actual store about which the user was informed through the electronic advertisement in the electronic mall. The user purchases the product and hands over the coupon upon payment.

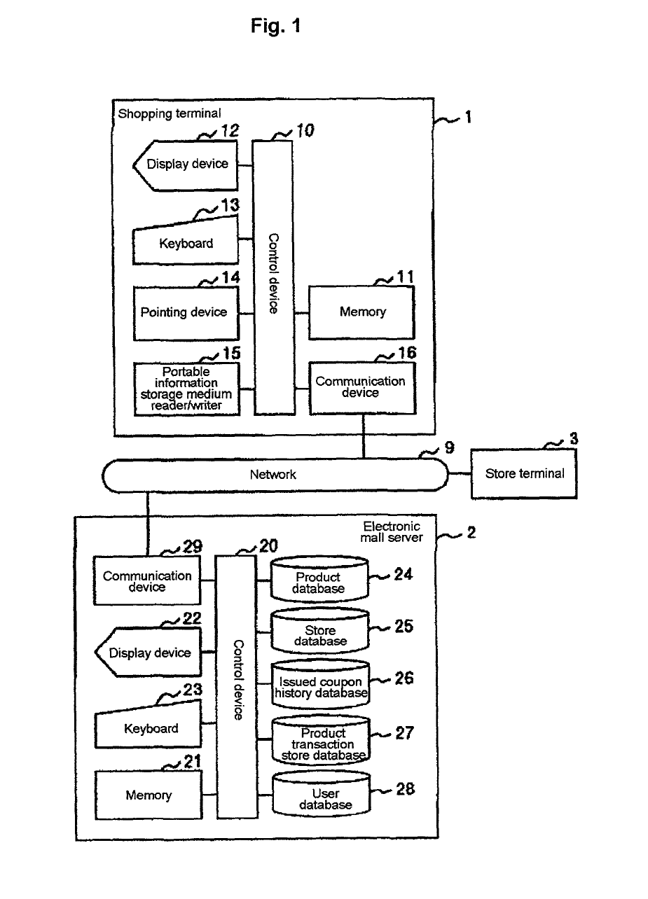

FIG. 1 is a block diagram showing the system architecture of an electronic mall system in which the present invention is implemented. In this system, a network 9 connects a shopping terminal 1 through which a user can shop electronically, an electronic mall server 2 that provides electronic advertisements, and a store terminal 3 for carrying out product purchase transactions. In this example, there are multiple electronic mall servers 2, shopping terminals 1, and store terminals 3 connected to network 9, and each shopping terminal 1 can freely access any of the electronic mall servers 2.

Shopping terminal 1 includes a control device 10 controlling the entire terminal, a display device 12, a keyboard 13, a pointing device 14 used to operate the terminal for product searches, and the like, a memory 11, a communication device 16, and a portable information storage medium reader/writer 15 that allows information to be read from and written to a portable information storage medium such as an IC card or memory stick. Control device 10 executes programs stored in memory 11 and performs product search operations while exchanging data with electronic mall server 2. Shopping terminal 1 may be either a dedicated terminal or a general-purpose information terminal such as a personal computer (PC), a portable information terminal, or a portable phone.

Electronic mall server 2 includes a control device 20 that is a server computer controlling the entire server, a memory 21 connected to control device 20, a communication device 29, a product database 24 in a storage device, a store database 25, a product transaction store database 27, an issued coupon history database 26, a user database 28, a display device 22, and an input device 23 such as a keyboard. In response to requests from shopping terminal 1, product information stored in product database 24 and store information stored in store database 25 are sent. Further, in response to user requests, store coupons selected by users are sent to user shopping terminals 1 through network 9. When this is done, issued coupon information is stored in issued coupon history database 26. Display device 22 and keyboard 23 are used for maintenance of programs and data in the electronic mall server. Shopping terminal 1 is connected by way of network 9 to electronic mall server 2.

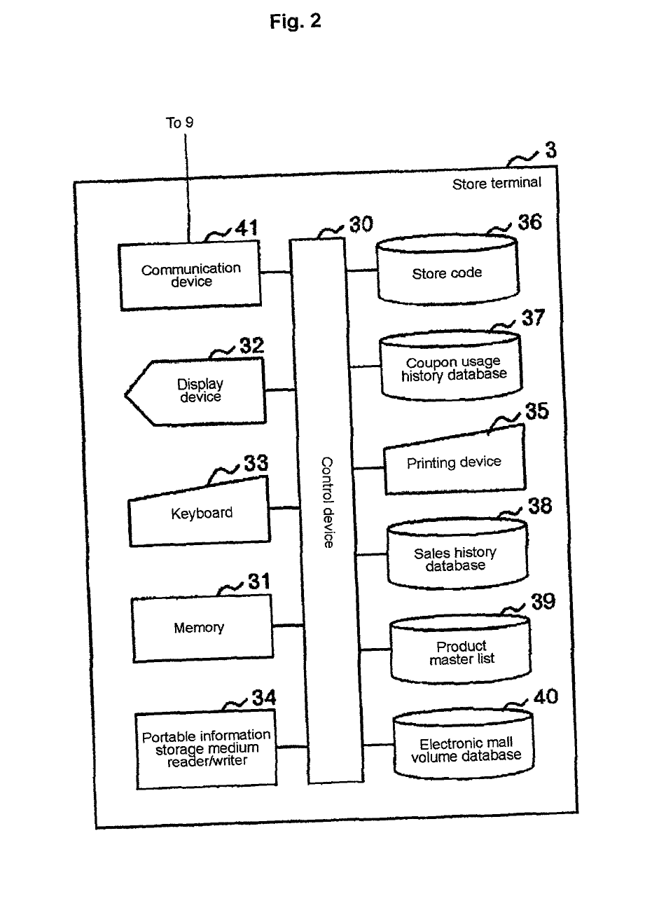

FIG. 2 is a block diagram showing the architecture of a store terminal 3 in a physical store. Store terminal 3 is installed in a physical store and is used to carry out product purchase transactions with users visiting the store. A control device 30 controlling store terminal 3 is connected to a display device 32, a keyboard 33, a printing device 35, a communication device 41, a memory 31, a portable information storage medium reader/writer 34, a store code 36 in a storage device, a coupon usage history database 37, a sales history database 38, a product master list 39, and an electronic mall volume database 40. Transaction information is displayed on display device 32 and keyboard 33 is used by the person handling the transaction to enter information into the terminal. Control device 30 executes programs stored in memory 31 and carries out transaction operations. Store code 36 stores a code used to uniquely identify the store. Sales history database 38 stores sales histories. Product master list 39 stores product codes and unit prices of products carried in the store. Display device 32 and keyboard 33 are also used for maintenance of programs and data in store terminal 3. Store terminal 3 can be a POS (point-of-sale) terminal, and is connected to electronic mall server 2 through network 9.

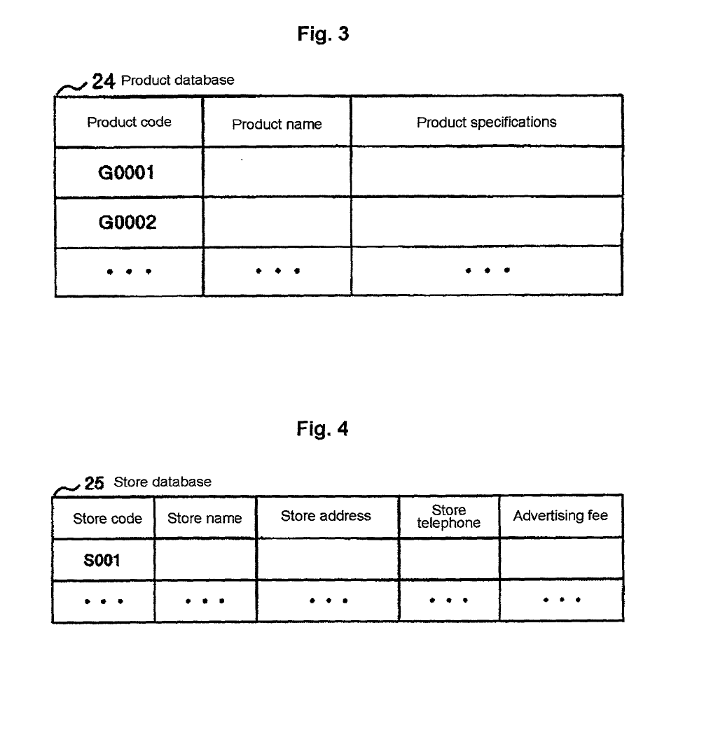

FIG. 3 shows sample contents of data stored in product database 24. In this example, the stored data includes a product code, a product name, and product specifications for each product. The product specifications here refer to the color, size, material, and the like, of the product.

FIG. 4 shows sample contents of data stored in store database 25. In this example, the stored data includes a store code, a store name, a store address, a store telephone number, and advertising fees. Electronic advertisement information may also be stored for each store.

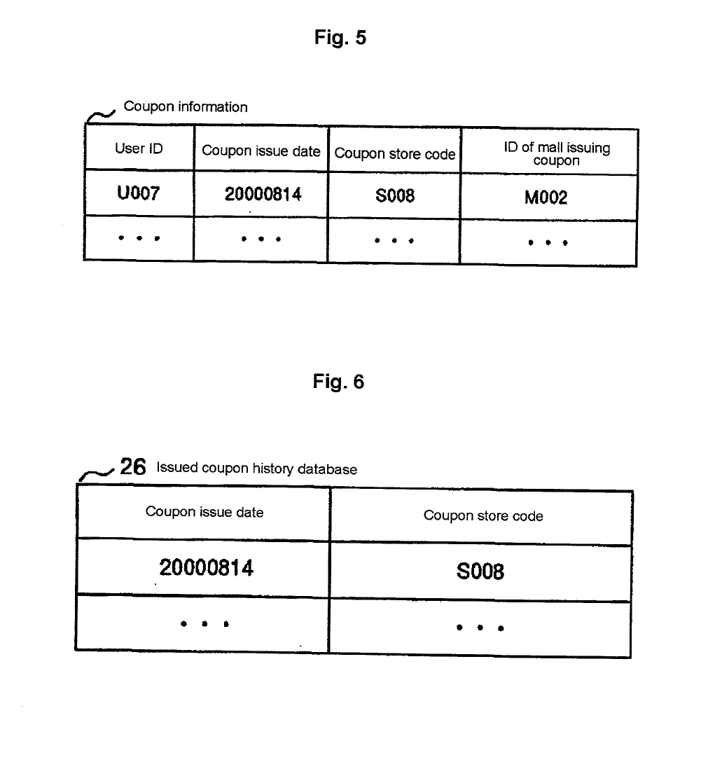

FIG. 5 shows sample contents of coupon information sent to shopping terminal 1. In this example, the transmitted information includes a user ID, coupon issue data, a coupon store code, and an electronic mall ID for the mall issuing the coupon. As an alternative, the URL of the electronic mall can be used instead of the electronic mall ID.

FIG. 6 shows sample contents of data stored in issued coupon history database 26. In this example, the stored data includes coupon issue dates and coupon store codes.

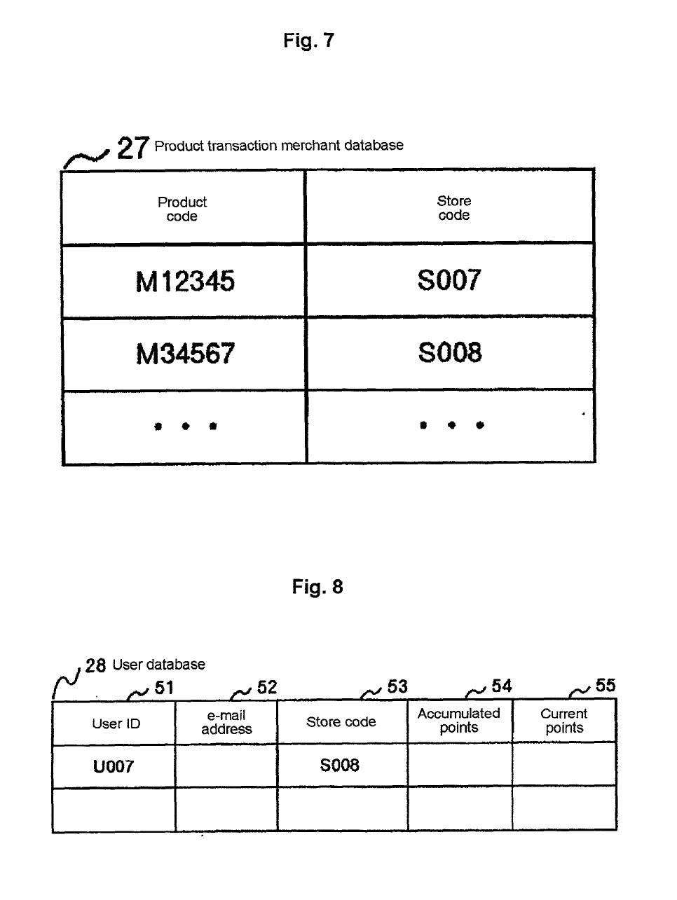

FIG. 7 shows sample contents of data stored in product transaction store database 27. In this example, the stored data includes product codes and the store code of the store handling the product.

FIG. 8 shows sample contents of data stored in user database 28. In this example, the stored data includes a user ID 51, an e-mail address 52, a store code 53, accumulated points 54, and current points 55. E-mail address 52 is the e-mail address the user supplied in requesting a coupon from server 2 via e-mail. Store code 53 is a store code associated with the coupon. Accumulated points 54 refers to the number of points, accrued over a fixed period, that are used to calculate electronic advertising fees. Current points 55 is the number of points currently held by the user.

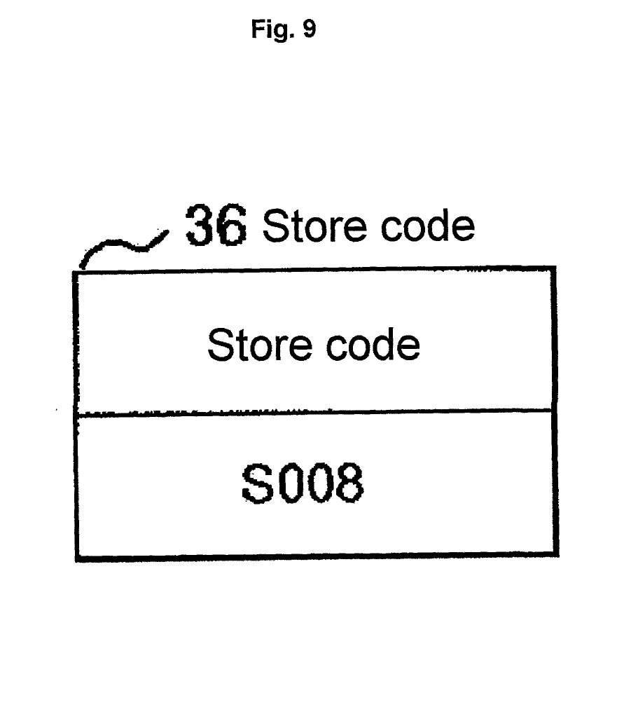

FIG. 9 shows sample contents of data stored in the store code 36. In this example, the stored data is a store code, S008.

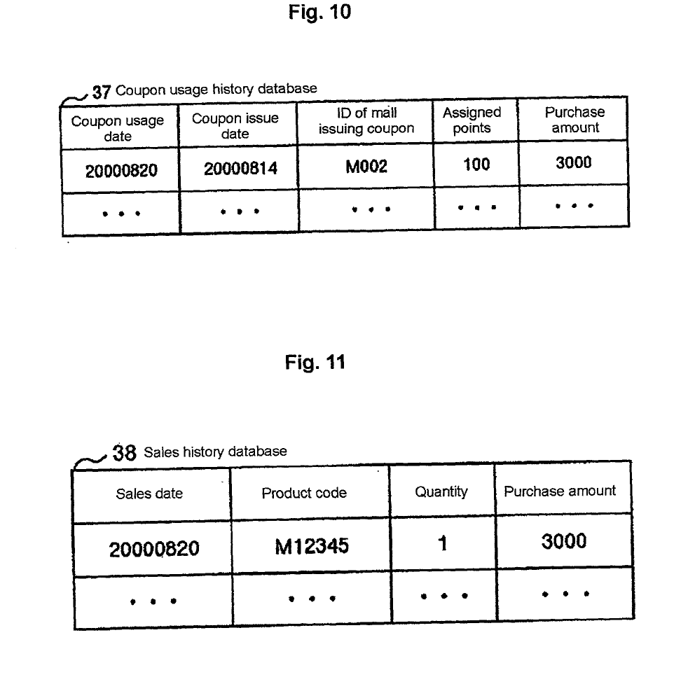

FIG. 10 shows sample contents of data stored in the coupon usage history database 37. In this example, the stored data includes coupon usage dates, coupon issue dates, IDs of electronic malls issuing coupons, points, and purchase amounts. The points field is not needed if a point system is not being used.

FIG. 11 shows sample contents of data stored in the coupon usage history database 37. In this example, sales dates, product codes, quantities, and purchase amounts are stored.

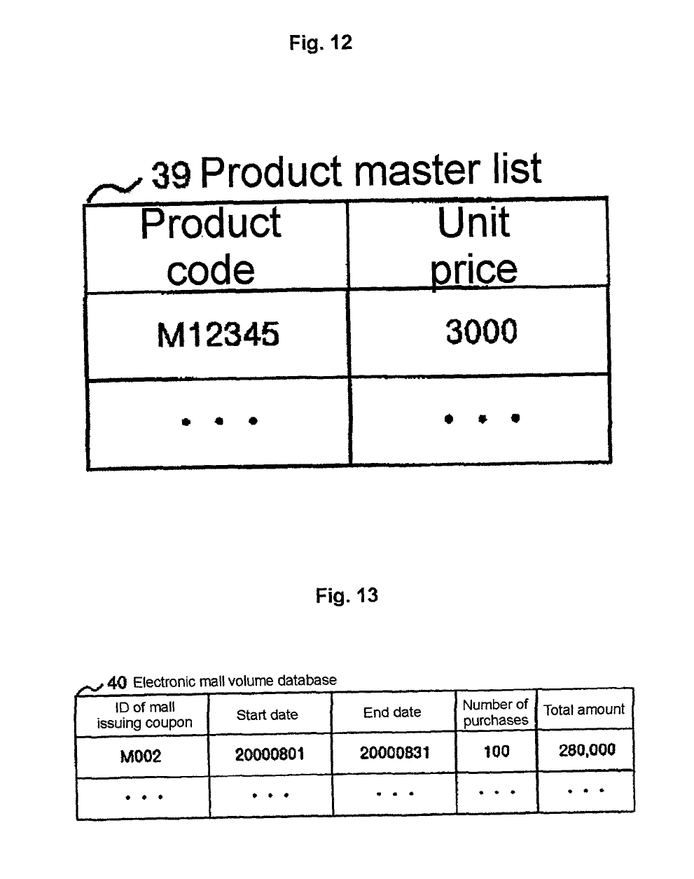

FIG. 12 is an example of a product master list 39 in which product codes and unit prices are stored.

FIG. 13 shows sample contents of data stored in the electronic mall volume database 40. In this example, the stored data includes the IDs of electronic malls issuing coupons, start dates, end dates, number of purchases, and total amounts.

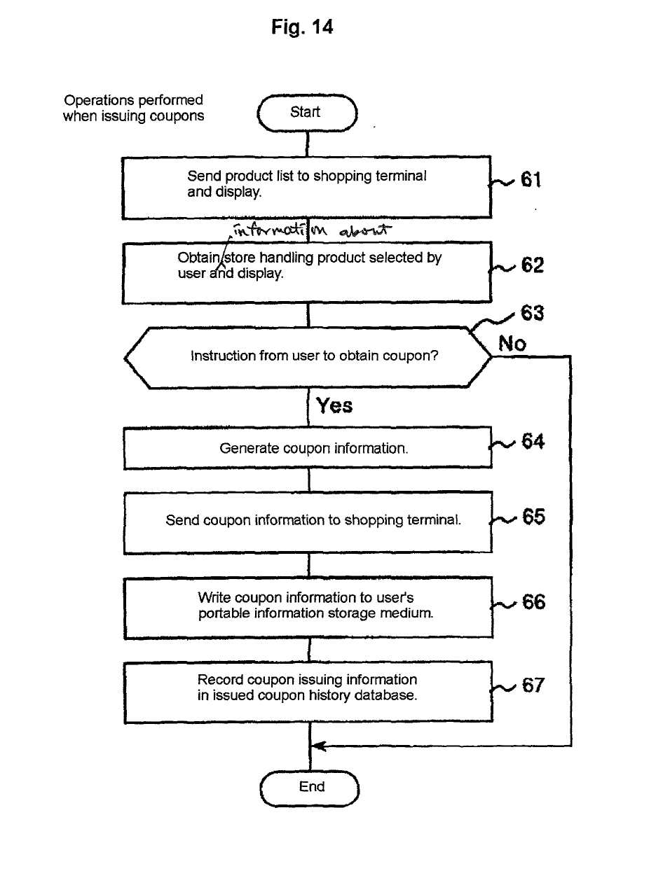

FIG. 14 is a flowchart showing the flow of operations performed by electronic mall server 2 and shopping terminal 1 when a coupon is issued. In response to a request from shopping terminal 1, the program in electronic mall server 2 looks up product database 24, generates a list of products, and sends it to the shopping terminal 1. Shopping terminal 1 displays this list of products on display device 12 (step 61). The user uses pointing device 14 or keyboard 13 to select a product, and shopping terminal 1 sends the product code to electronic mall server 2. Electronic mall server 2 looks up product transaction store database 27 and obtains the store code of the store handling the product. Then, electronic mall server 2 looks up store database 25 to obtain the store name, address, and telephone number, and sends this information to shopping terminal 1. Shopping terminal 1 displays the information about the store on display device 12 (step 62). In this step, all or part of the transmitted content consists of the electronic advertisement for the store.

If the user requests a coupon (step 63, Yes), shopping terminal 1 sends this instruction and a user ID to electronic mall server 2, which generates coupon information containing a store code, and an ID for the mall issuing the coupon (step 64). This coupon information is sent to shopping terminal 1 (step 65). Shopping terminal 1 uses the portable information storage medium reader/writer 15 to write the coupon information to the user's portable information storage medium (step 66). Electronic mall server 2 records the coupon issue date and the store code associated with the coupon in issued coupon history database 26 (step 67).

If the user does not request a coupon (step 63, No), electronic mall server 2 exits the operation. The user can then use the virtual store in electronic mall server 2 to purchase the product using conventional methods. When products are purchased from virtual stores, electronic mall server 2 records the corresponding sales history in the sales history database 38 for each store.

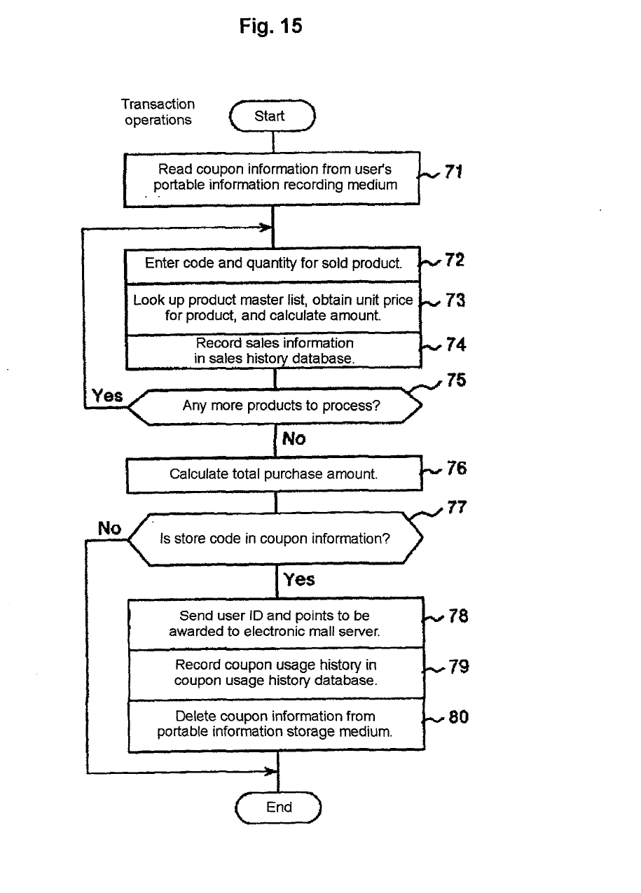

FIG. 15 is a flowchart showing the flow of operations performed by store terminal 3 to carry out transactions. The program in the store terminal uses portable information storage medium reader/writer 34 to read coupon information from the portable information storage medium brought by the user (step 71). Using keyboard 33, the user enters the product code and quantity of the product sold (step 72). Next, the product master list 39 is looked up to obtain the product unit price, and this is multiplied by the quantity being purchased to calculate the price of the purchase (step 73). Next, the sales date, the product code, the quantity, and the price are written to the sales history database 38 (step 74). The operations in steps 72-74 are repeated until all products have been processed (step 75).

When all product transactions have been processed, the total purchase amount is calculated (step 76). At this point, the price may be discounted if the user provides coupon information. The total purchase price may be the amount after the discount has been calculated. Moreover, coupons do not have to be for discounts, and may be coupons for free or service tickets to amusement parks or the like. Alternatively, coupons can serve as purchase reservation tickets.

Next, the coupon store code in the coupon information read at step 71 is checked to see if it matches the store code in the storage device (step 77). If the two values match, the points associated with the purchase amount and the user ID contained in the coupon information are sent to electronic mall server 2 (step 78). Next, the coupon usage date, the coupon issue date, the ID of the electronic mall issuing the coupon, the points earned from the purchase, and the purchase amount are recorded in coupon usage history database 37 (step 79). Then, the coupon information in the portable information storage medium is deleted (step 80).

If the coupon store code read at step 71 does not match store code 36 (step 77, No), the coupon information is not for this store, so it is not processed as part of the electronic advertising fee and the operation is exited.

If the user uses points from current points 55, a corresponding discount is applied and keyboard 33 is used to send the user ID and the number of points to be used from store terminal 3 to electronic mall server 2.

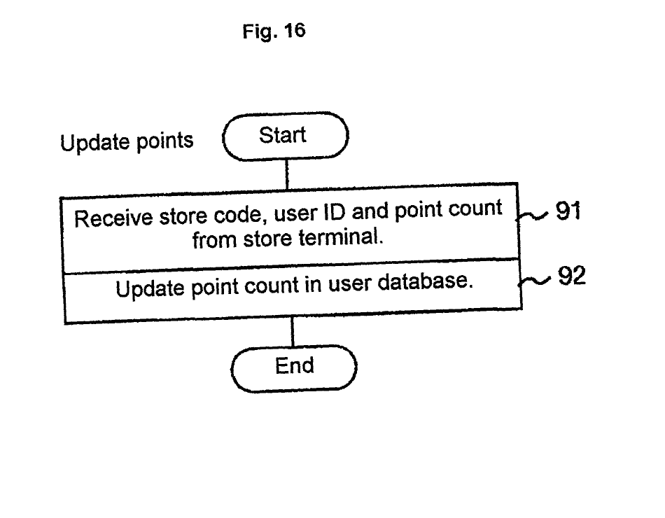

FIG. 16 is a flowchart showing the flow of operations performed by electronic mall server 2 when updating points. From store terminal 3, electronic mall server 2 receives a store code, a user ID, a point count, and an indication of whether points are to be added or used (step 91). User database 28 is looked up to update the accumulated points 54 and the current points 55 for the record associated with the user ID 51 and store code 53 (step 92). If points are to be added, the point count is added to the accumulated points 54 and the current points 55. If points are to be used, the point count is subtracted from the current points 55.

The user can send a user ID from shopping terminal 1 to electronic mall server 2 to query the current point count for the user. Electronic mall server 2 looks up user database 28 using the user ID 51 and, for each store, sends the current points 55 to the shopping terminal 1. Shopping terminal 1 then displays the current points for each store on output module 12. A worker at store terminal 3 can also look up the current points of the user from electronic mall server 2 using store terminal 3.

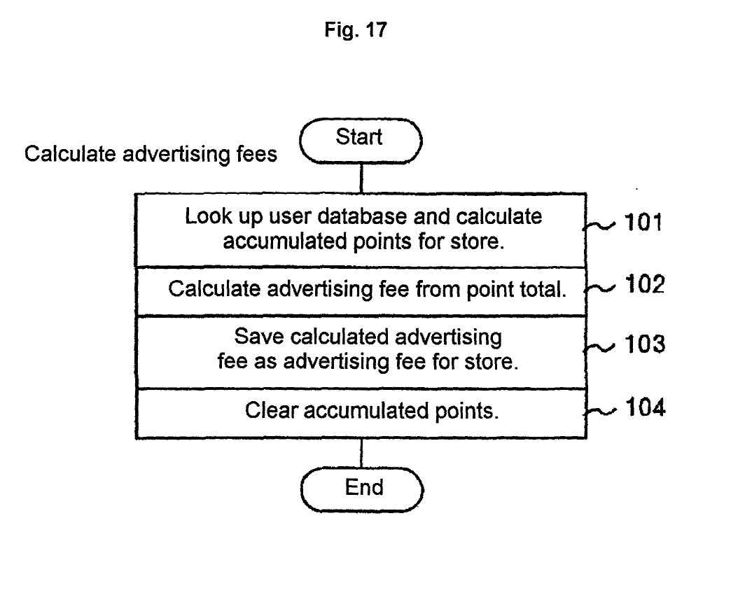

FIG. 17 is a flowchart showing the flow of operations performed by electronic mall server 2 when calculating advertising fees. First, electronic mall server 2 looks up user database 28 and, for each store, extracts the accumulated points 54 for a fixed period and calculates total points (step 101). Next, the calculated total points are multiplied by a fixed amount to calculate the advertising fee (step 102). Then, the calculated advertising fee is stored in the advertising fee fields for the stores in store database 25 (step 103). Finally, user database 28 is looked up and the accumulated points 54 for the fixed period for the store is cleared (step 104).

Steps 101-104 are repeated for each of the stores stored in user database 28. To group multiple stores together for calculating advertising fees, store code 53 can be divided into a high-order code and a low-order code. High-order code values can be shared by multiple stores, and the operations described above can be performed in the order of their high-order code values.

In the embodiment described above, a coupon retrieval instruction is sent from shopping terminal 1 to electronic mall server 2 at step 63. Alternatively, it is possible to send a coupon retrieval request from shopping terminal 1 to electronic mall server 2 via electronic mail instead. In this case, electronic mall server 2 uses e-mail address 52 of the coupon retrieval request message sent by the user as a key to look up user database 28 and retrieve the associated user ID 51. If the user is not in user database 28, a unique user ID is generated. Next, electronic mall server 2 sends coupon information to shopping terminal 1 in the form of an e-mail message. Shopping terminal 1 receives the coupon information and either writes the information to a portable information storage medium using portable information storage medium reader/writer 15, or stores the information in memory 11 so that it can be displayed on display device 12.

At step 66, the coupon information is written to the portable information storage medium at shopping terminal 1, and the coupon information in this portable information storage medium is read by store terminal 3 at step 71. As an alternative, it would also be possible to store the coupon information in memory 11 so that it can be displayed by display device 12. The coupon information can then be presented to employees of the physical store using display device 12. In addition, it is possible to display the current point count of the user on display device 12 for the employee and to request point usage.

In the description above, point counts are registered and updated in electronic mall server 2, and advertising fees for individual stores are calculated based on accumulated points. Alternatively, it is also possible to have the total purchase amounts involving coupons sent from store terminal 3 at each store to electronic mall server 2. In this case, step 78 in the transaction operation performed by store terminal 3 is eliminated.

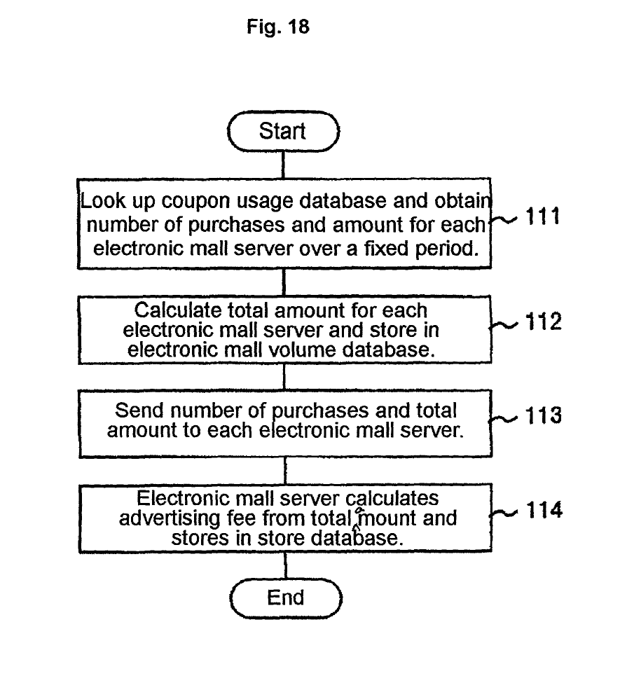

FIG. 18 is a flowchart showing the flow of operations performed by store terminal 3 and electronic mall server 2 when calculating advertising fees according to another embodiment. Store terminal 3 looks up coupon usage history database 37 and obtains the number of purchases and their amounts for an electronic mall during a fixed period (step 111). Next, a total amount is calculated for the electronic mall, and the ID of the electronic mall, a start date, an end date, the number of purchases, and the total amount are stored in electronic mall volume database 40 (step 112). Then, the store code, the number of purchases, and the total amount are sent to electronic mall server 2 (step 113). Electronic mall server 2 receives this information and takes a fixed rate of the total amount to calculate the advertising fee. The calculated advertising fee is stored in the advertising fee field for the store in store database 25 (step 114). Electronic mall server 2 can use the received number of purchases for checking, but it is also possible to calculate the advertising fee by taking a fixed rate of the number of purchases rather than the total purchase amount. Store terminal 3 repeats the operations of steps 111-113 for each of the electronic malls recorded in coupon usage history database 37. Each electronic mall server 2 performs the operation in step 114 for each store sending information.

In this embodiment, it is also possible to have coupon retrieval requests sent from shopping terminal 1 to electronic mall server 2 as an electronic mail message. Further, instead of passing coupon information from shopping terminal 1 to store terminal 3 using a portable information storage medium, it is possible to store the information in memory 11 so that the data can be displayed on display device 12, and to have this information displayed to a store employee using the display device 12.

The two embodiments described above use portable information storage media, alternatively, coupon information can be recorded in a portable information terminal such as a portable telephone. The portable terminal can then be taken to the store, and the coupon information can be sent to the store transaction terminal using wireless technology.

In the two embodiments described above, coupons are issued by store, but it is also possible to issue coupons by store and product in another embodiment.

The two embodiments described above provide benefits for the electronic mall, the user, and the store. For the electronic mall, there is an increased number of electronic advertisement viewers due to users seeking coupons. If a point system is used, users seeking points will increase the number of electronic advertisement viewers. As a result, advertising income can be increased, and the breakdown of the advertising fee income generated by users who visit the physical stores can be determined. For the user, discounts are provided through coupons. If a point system is used, special benefits can be obtained by accumulating points. For the store, the number of customers is increased by those coming for coupon discounts. If a point system is used, the number of customers is increased by those coming for special benefits from points. In addition, the electronic advertising fees that are charged can be based rationally on the effects of the electronic advertisement.

When purchase amounts (or number of purchases) or point information associated with coupon use is sent from store terminal 3 to electronic mall server 2, the advertising fee for the electronic advertisement increases by a corresponding amount. Thus, whether or not purchase amounts (or number of purchases) or point information is correctly reported from store terminal 3 to electronic mall server 2 may be an issue. However, offering coupons and points increases the possibility that customers will come to the store, thus providing a benefit for the store. In particular, when a point system is used, a user will complain if point information is not sent from store terminal 3 to electronic mall server 2 because the user will see that his or her points are not increased. Thus, the store will be compelled to send point information to electronic mall server 2. Furthermore, if the electronic mall handles the fees required for points using user database 28, or the like, the store will actively send point information to electronic mall server 2.

If a user sends a coupon to a friend and the friend uses the coupon, this will increase the number of customers visiting the physical store and is therefore not a problem. Because the user's points will increase even if a friend uses the coupon, the user will be able to receive special benefits. Furthermore, if the user tells friends about the system, the friends, themselves, can view the electronic advertisements and obtain coupons, thus increasing the number of people viewing the electronic advertisements.

The calculations of advertising fees resulting from a user using the virtual stores in electronic mall server 2 to purchase products will not be described in detail here but advertising fees can be calculated in a rational manner analogous to that described above for the physical stores.

According to the present invention, in the calculation of electronic advertising fees, it is possible to reliably determine if a user coming to a store and purchasing a product is a user who saw an electronic mall advertisement or not. Accordingly, the benefits of the electronic advertisements can be determined in a reliable manner.

The preferred embodiment of the present invention having been described in detail, persons skilled in the art will appreciate that modifications and variations of the present invention can be made without departing from the spirit or scope of the invention as defined by the claims.

What is claimed is:

1. In a network environment for conducting electronic commerce activities, a method of calculating advertising fees for an electronic advertisement comprising:
displaying contents of an electronic advertisement for a store on a user terminal via a network;
storing in the user terminal, via the network, coupon information containing information which identifies the store; and
calculating an advertising fee for displaying the electronic advertisement based on a product purchase amount if the coupon information stored in the user terminal is transmitted to the store.

2. A method as recited in claim 1 wherein the coupon information is transmitted to the store when the coupon information is displayed on the user terminal at the store.

3. A method as recited in claim 1 wherein the coupon information is transmitted to the store when the coupon information is transferred from the user terminal to a store terminal at the store.

4. A method as recited in claim 1 wherein storing the coupon information comprises storing the coupon information in a portable information storage medium which is used to transmit the coupon information to the store.

5. In a network environment for conducting electronic commerce activities, a method of calculating advertising fees for an electronic advertisement comprising:
sending an electronic advertisement about a store to a user;
generating coupon information containing information which identifies the store and sending the coupon information to the user;
receiving from the store reports on coupon usage and product purchase amounts associated with the coupon information sent to the user; and
calculating advertising fees for sending the electronic advertisement about the store based on the reported coupon usage and product purchase amounts.

6. A method as recited in claim 5 wherein the electronic advertisement and the coupon information are sent to a user terminal at the user.

7. In a network environment for conducting electronic commerce activities, a method of calculating advertising fees for an electronic advertisement comprising:
displaying contents of an electronic advertisement for a store on a user terminal via a network;
storing in the user terminal, via the network, coupon information containing information which identifies the store; and
calculating an advertising fee for displaying the electronic advertisement based on points assigned to product purchases associated with coupon usage corresponding to the coupon information stored in the user terminal.

8. A method as recited in claim 7 wherein the coupon information is transmitted to the store when the coupon information is displayed on the user terminal at the store.

9. A method as recited in claim 7 wherein the coupon information is transmitted to the store when the coupon information is transferred from the user terminal to a store terminal at the store.

10. In a network environment for conducting electronic commerce activities, a method of calculating advertising fees for an electronic advertisement comprising:
sending an electronic advertisement about a store to a user;
generating coupon information containing information which identifies the store and sending the coupon information to the user;
receiving from the store reports on points assigned to product purchases associated with coupon usage corresponding to the coupon information sent to the user; and
calculating advertising fees for sending the electronic advertisement about the store based on the reported points.

11. A method as recited in claim 10 wherein an accumulated point count is stored for the store on product purchases associated with coupon usage by the user, wherein the user is assigned points for each product purchase associated with coupon usage corresponding to the coupon information sent to the user, wherein the assigned points are added to the accumulated point count, and wherein the advertising fees are calculated based on the accumulated point count.

12. A method as recited in claim 10 wherein the assigned points are added to a current point count for the user, and wherein when points are used, the used point are subtracted from the current point count for the user.

13. In a network environment for conducting electronic commerce activities, a system of calculating advertising fees for an electronic advertisement having an electronic mall server which comprises:
an advertisement sending module configured to send an electronic advertisement about a store to a user;
a coupon generating module configured to generate coupon information containing information which identifies the store and send the coupon information to the user;
a coupon usage module configured to receive from the store reports on coupon usage and product purchase amounts associated with the coupon information sent to the user; and
a fee calculating module configured to calculate advertising fees for sending the electronic advertisement about the store based on the reported coupon usage and product purchase amounts.

14. A system as recited in claim 13 further comprising a user terminal at the user which receives the electronic advertisement and the coupon information from the electronic mall server, wherein the user terminal comprises:
an advertisement receiving module configured to receive the electronic advertisement from the electronic mall server; and
a coupon receiving module configured to receive and store the coupon information from the electronic mall server.

15. A system as recited in claim 14 further comprising a store terminal at the store, the store terminal comprising:
a coupon storage module configured to store coupon information transferred from the user terminal; and
a purchase reporting module configured to report to the electronic mall server amounts of product purchases associated with the coupon information sent to the user.

16. In a network environment for conducting electronic commerce activities, a system of calculating advertising fees for an electronic advertisement having an electronic mall server which comprises:
an advertisement sending module configured to send an electronic advertisement about a store to a user;
a coupon generating module configured to generate coupon information containing information which identifies the store and send the coupon information to the user;
a coupon usage module configured to receive from the store reports on coupon usage and product purchase amounts associated with the coupon information sent to the user; and
a fee calculating module configured to calculate advertising fees for sending the electronic advertisement about the store based on points assigned to product purchases associated with coupon usage corresponding to the coupon information sent to the user.

17. A system as recited in claim 16 further comprising a user terminal at the user which receives the electronic advertisement and the coupon information from the electronic mall server, wherein the user terminal comprises:
an advertisement receiving module configured to receive the electronic advertisement from the electronic mall server; and
a coupon receiving module configured to receive and store the coupon information from the electronic mall server.

18. A system as recited in claim 17 further comprising a store terminal at the store, the store terminal comprising:
a coupon storage module configured to store coupon information transferred from the user terminal; and
a purchase reporting module configured to report to the electronic mall server points assigned to product purchases associated with coupon usage corresponding to the coupon information sent to the user.

19. A computer program product stored on a computer readable medium for facilitating electronic commerce transactions, the computer program product comprising:
code for sending an electronic advertisement about a store to a user;
code for generating coupon information containing information which identifies the store and sending the coupon information to the user;
code for receiving from the store reports on coupon usage and product purchase amounts associated with the coupon information sent to the user; and
code for calculating advertising fees for sending the electronic advertisement about the store based on the reported coupon usage and product purchase amounts.

20. A computer program product stored on a computer readable medium for facilitating electronic commerce transactions, the computer program product comprising:
code for sending an electronic advertisement about a store to a user;
code for generating coupon information containing information which identifies the store and sending the coupon information to the user;
code for receiving from the store reports on points assigned to product purchases associated with coupon usage corresponding to the coupon information sent to the user; and
code for calculating advertising fees for sending the electronic advertisement about the store based on the reported points.
